(19) United States
(12) Patent Application Publication
(10) Pub. No.: US 2015/0324047 A1
(43) Pub. Date: Nov. 12, 2015

(54) TOUCH PANEL INCLUDING PATTERNS OF MESH STRUCTURES

(71) Applicant: LG INNOTEK CO., LTD., Seoul (KR)

(72) Inventors: Yong Suk KIM, Seoul (KR); Bong Jun PARK, Seoul (KR); Seongsu OEM, Seoul (KR); Young Sun YOU, Seoul (KR); Jinwoong LEE, Seoul (KR)

(21) Appl. No.: 14/706,244

(22) Filed: May 7, 2015

(30) Foreign Application Priority Data
May 7, 2014 (KR) 10-2014-0054170
May 22, 2014 (KR) 10-2014-0061704

(51) Int. Cl. G06F 3/041

(52) U.S. Cl. CPC G06F 3/0412

(57) ABSTRACT

Disclosed herein is a touch panel. The touch panel can have improved electrical properties and implement a large size because it includes patterns of mesh structures. Furthermore, the visibility of a view region can be improved by increasing the density of meshes in a region in which patterns are intersected, excellent electrical properties can be implemented, and a panel fabrication process can be simplified.

### CROSS-REFERENCE TO RELATED APPLICATIONS

This application claims priority under 35 U.S.C. §119 to Korean Application No. 10-2014-0054170 and No. 10-2014-0061704 filed in the Korean Intellectual Property Office on May 7, 2014 and May 22, 2014 respectively, whose entire disclosures are hereby incorporated by reference.

### BACKGROUND

1. Field

The present invention relates to a touch panel and, more particularly, to a large-sized touch panel having improved electrical properties by forming patterns of mesh structures and a touch panel capable of improving the visibility of a view region, implementing excellent electrical properties, and simplifying a panel fabrication process by increasing the density of meshes in a region in which patterns are intersected.

2. Background

A touch panel refers to an apparatus attached to one surface of a display and configured to receive a touch input from a user. Specifically, the touch panel includes two conductive patterns having a crossing structure. Recently, active research is being carried on a GFF structure in which the two patterns are formed in separate sheets and the two sheets are stacked on glass and a G2 structure in which the two patterns are disposed in a single piece of glass and a connection structure, such as a bridge, is used in the region in which the two patterns are intersected.

The touch panel is an element that enables a user to perform a required function by touching a menu displayed on a screen while viewing the display, and needs to have light transmission or transparency of a specific level or more.

To this end, in general, a touch panel having excellent light transmission is implemented by forming transparent conductive patterns on a surface of a transparent plate.

A method of forming the conductive patterns on the substrate in implementing the touch panel is closely related to the visibility of the touch panel. Research is recently being carried out on various pattern formation methods. From among the methods, a technology for forming the conductive patterns to have a metal mesh structure formed of fine metal lines is newly proposed.

An embodiment of the present invention relates to a touch panel capable of improving the visibility of a display and more simplifying a manufacture process by controlling a line width at a point at which two patterns are intersected, implementing patterns of mesh structures, and increasing the density of checked patterns at the crossing point, that is, one of various methods for improving a pattern formation method.

### BRIEF DESCRIPTION OF THE DRAWINGS

The embodiments will be described in detail with reference to the following drawings in which like reference numerals refer to like elements wherein:

FIG. 1 is a diagram illustrating the state in which a conventional transparent conductive body has been formed on a substrate in relation to an embodiment of the present invention;

FIG. 2 is a diagram illustrating the state in which patterns of mesh structures in accordance with an embodiment of the present invention have been formed on a substrate and a structure in which two patterns are intersected;

FIG. 3 is a diagram illustrating a comparison between the density of meshes in a region in which patterns of mesh structures are intersected and the density of meshes in a region in which patterns of mesh structures are not intersected in a touch panel of FIG. 2; and

FIG. 4 illustrates an example in which a protection layer is further formed on a first pattern and a second pattern in accordance with an embodiment of the present invention.

### DETAILED DESCRIPTION

The details of the objects and technical configurations of the present invention and corresponding acting effects will become more clearly understood from the following detailed description based on the drawings accompanied by the specification of the present invention. Hereinafter, embodiments of the present invention are described in detail with reference to the accompanying drawings.

The embodiments disclosed in this specification should not be construed or used as limiting the scope of the present invention. It is evident to those skilled in the art that a description including the embodiments of this specification may be modified in various ways. Accordingly, specific embodiments described in the detailed description of the present invention are illustrative for a better description of the present invention, and the scope of the present invention is not intended to be restricted by the embodiments.

Function terms illustrated in the drawings and described below are only examples of possible expressions. In other embodiments, other terms may be used without departing from the spirit and scope of the detailed description.

Furthermore, it should be understood that an expression that some elements are “included” is an expression of an “open type” and the expression simply denotes that a corresponding element is present, but does not exclude additional elements.

Furthermore, when it is said that each layer (or film), area, pattern, or structures are formed “over/on” or “under/below” a substrate, each layer (or film), region, pad, or patterns, it should be understood that the layer (or film), area, pattern, or structures are “directly” formed on the substrate, layer (or film), region, pad, or patterns or formed on the substrate, layer (or film), region, pad, or patterns with another layer interposed therebetween.

Furthermore, when it is said that one element is “connected” to the other element, it should be understood that one element may be directly connected to the other element, but a third element may be present between the two elements

Furthermore, terms, such as the first and the second, may be used to describe various elements, but the elements should not be restricted by the terms. The terms are used to only distinguish one element and the other element from each other.

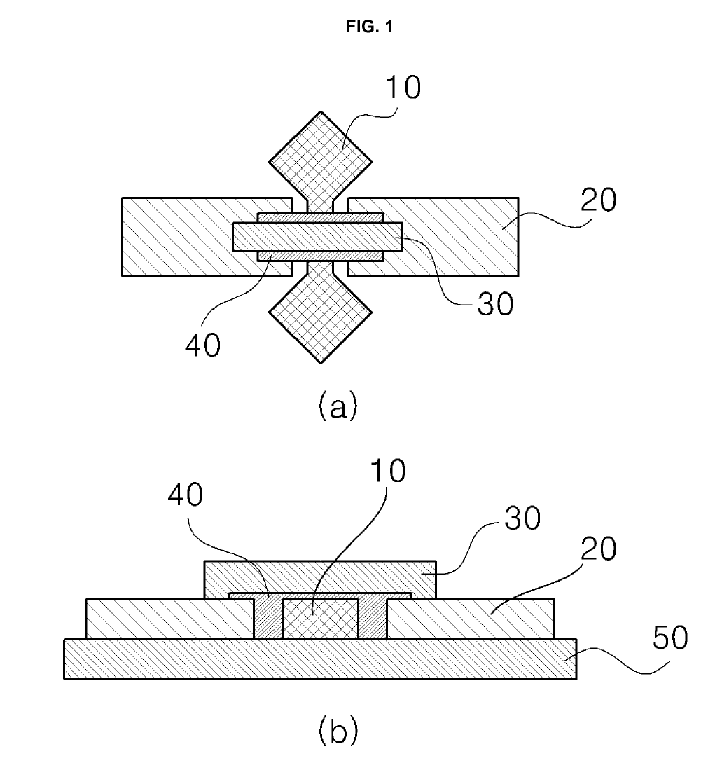

FIG. 1 is a diagram illustrating the state in which a conventional transparent conductive body has been formed on a substrate in relation to an embodiment of the present invention.

Many touch panels so far have been fabricated using a transparent conductive substance, representatively, using indium tin oxide (ITO) as illustrated in FIG. 1.

FIG. 1(a) illustrates first patterns 10 arranged in a specific direction, second patterns 20 arranged in a direction different from the specific direction, an insulator 40 configured for insulation and connection between the first patterns 10, and a connection structure 30 configured for insulation and connection between the second patterns 20.

In this case, the first pattern 10 and the second pattern 20 are configured to include the transparent conductive substance and to have a plane structure not a mesh structure.

FIG. 1(b) illustrates the touch panel of FIG. 1(a) when viewed from the front. It may be seen that a transparent substrate 50 is placed at the bottom of the touch panel and the first patterns 10, the second patterns 20, the insulator 40, and the connection structure 30 are sequentially stacked over the transparent substrate 50.

In the case of a touch panel using the transparent conductive body of a common plane structure not a mesh structure as in FIG. 1, the substrate 50 and the patterns themselves may maintain the visibility of a display to a specific level using a transparent substance. However, there is a problem in that visibility is halved if a corresponding area is increased because a plurality of regions in which the patterns are intersected, that is, a plurality of the connection structures 30 is formed. If resistance of the transparent conductive body is to be improved in order to improve electrical properties, there may be a side effect because the visibility of a pattern is deteriorated.

Furthermore, there may be a problem in that the visibility of the touch panel is halved because the area of the insulator 40 as well as the area of the connection structure 30 is increased. In order to solve such a problem, efforts to reduce the area of the insulator 40 continue to be made.

In addition, there is a problem in that much time and cost are required in a manufacture process in order to implement a touch panel having a structure, such as that of FIG. 1. Specifically, in order to pattern the transparent conductive body, a four-step process, such as a laminating step, an exposure step, a development step, and an etching step, need to be performed on the substrate 50. The insulator 40 and the connection structure 30 are formed on the patterns on the substrate 50 formed through such steps, thereby completing the final touch panel. Accordingly, a complicated multi-step process is required to fabricate a touch panel having a structure, such as that of FIG. 1.

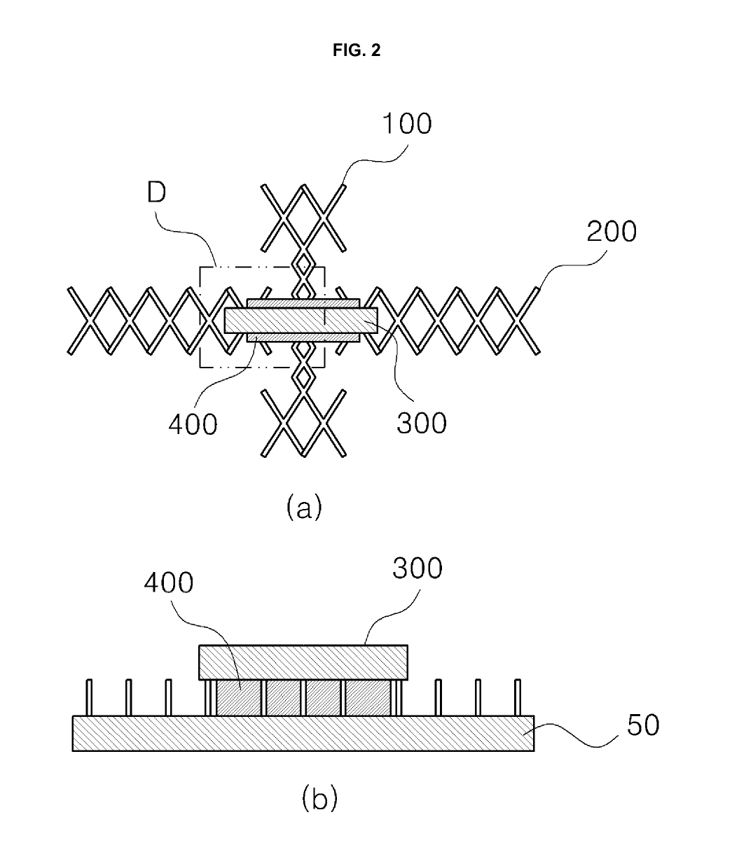

A touch panel in accordance with an embodiment of the present invention is described below with reference to FIG. 2.

Referring to FIG. 2, the touch panel in accordance with an embodiment of the present invention basically includes a substrate 50, first patterns 100, second patterns 200, an insulator 400, and a connection structure 300.

First, the substrate 50 forming a base for the touch panel means a member made of a transparent material. The substrate 50 may be made of glass or made of a non-conductive transparent material including polymer, such as or PET or PEN. The substrate 50 may commonly have a sheet shape. In this case, a member having the sheet shape may be implemented using a member made of a flexible material so that it can be bent or curved, that is, flexible.

The insulator 400 is a structure that functions to provide insulation between the first patterns 100 and the second patterns 200 on a surface of the substrate 50, and may be made of a non-conductive transparent (or clear) insulating substance.

Furthermore, referring to FIG. 2(b), the insulator 400 may be formed by filling an insulating substance in the empty lattice spaces of patterns having a mesh structure. In this case, the insulating substance is filled in the spaces between the first patterns 100 and the second patterns 200 so that the first patterns 100 and the second patterns 200 are not connected.

The connection structure 300, that is, another element of the touch panel in accordance with an embodiment of the present invention, refers to a structure for connecting the disconnection regions of the second patterns 200.

The connection structure 300 is placed on top of the insulator 400, and connects the disconnection parts of the second patterns 200. That is, the connection structure 300 is disconnected from the first patterns 100 because it is placed on top of the insulator 400 in structure, and it includes only a structure for connecting the second patterns 200. In this case, the connection structure 300 may be made of a metallic substance, a transparent conductor, or a conductive polymer. For example, the connection structure 300 may be made of a transparent conductive substance, such as indium tin oxide (ITO), indium zinc oxide (IZC), or zinc oxide (ZnO). As will be described later, the connection structure 300 may also be configured to have a mesh shape.

The first pattern 100 refers to one of patterns formed on a surface of the substrate 50 and may correspond to any one of a Tx pattern through which a current signal transmitted in order to detect a touch passes and an Rx pattern for receiving a returned current signal.

The second patterns 200 are formed in a direction different from the direction of the first patterns 100 formed on a surface of the substrate 50. The second patterns 200 are disconnected in regions in which they cross the first patterns 100. Furthermore, the second pattern 200 has the attributes of an Rx pattern if the first pattern 100 is a Tx pattern and has the attributes of a Tx pattern if the first pattern 100 is an Rx pattern. Accordingly, different patterns having the attributes of the Tx pattern and the Rx pattern are repeatedly intersected and formed on a surface of the substrate 50.

In this case, the first patterns 100 and the second patterns 200 may be made of gold, silver, platinum, copper, nickel, chrome, molybdenum or an alloy of one or more of them. In addition, the first patterns 100 and the second patterns 200 may be made of a metal oxide substance having electrical conductivity. For example, the first patterns 100 and the second patterns 200 may include metal oxide, such as indium tin oxide, indium zinc oxide, copper oxide, tin oxide, zinc oxide, or titanium oxide, and may include nanowires, photoresist nanowire films, carbon nanotube (CNT), graphene, conductive polymer, or other various metal.

Furthermore, in the touch panel of FIG. 2 in accordance with an embodiment of the present invention, the first and the second patterns 100, 200 may have mesh structures. That is, as illustrated in FIG. 2, the first and the second patterns 100, 200 may have mesh structures having a plurality of checked patterns in respective directions. FIG. 2 illustrates an example in which the mesh structure has a diamond shape. In some embodiments, the mesh structure is not limited to the diamond shape, but may have a polygon, a circle, an oval, or an irregular crossing structure.

If the patterns are formed to have the mesh structures, the visibility of a display can be improved because a total area occupied by the patterns is reduced compared to conventional plane patterns. Furthermore, in terms of the process, the patterns having the mesh structures can be easily implemented on a surface of the substrate 50 using an offset printing method. Accordingly, there are advantages in that the process can be simplified and a cost can be reduced compared to conventional patterns formed using four or more steps.

Furthermore, the embodiment of FIG. 2 may have advantages in that the visibility and electrical properties of the touch panel are improved by controlling the line widths of the first patterns 100 and the second patterns 200 in a specific region or controlling the density of the mesh structures, that is, the number of checked patterns formed per unit area.

Furthermore, a possibility that a short may occur in a connection part with the first pattern 100 can be minimized because the mesh structures in the intersection region are densely formed. Accordingly, the touch panel may have maximum electrical properties and a resistance characteristic.

Specifically, a region in which the first patterns 100 and the second patterns 200 are intersected is described below. From FIG. 2, it may be seen that the first patterns 100 in the intersection region have mesh structures having a relatively dense form and mesh structures having a wide interval in other regions. In this case, the reason why the mesh structures in the intersection region are densely formed is to minimize the area of the intersection region, that is, the area of the connection structure 300, and also to provide a proper stacking environment for the connection structure 300.

In general, in the touch panel of a display device, in particular, in a touch panel in which patterns in two directions are formed on a single surface of the substrate 50, the visibility of the display device is changed depending on the area and number of the connection structures 300 in the regions in which the patterns intersected and the area of the insulator 400. For this reason, various attempts are recently made in order to minimize a reduction of visibility attributable to the connection structure 300 and the insulator 400. That is, if the region in which the first patterns and the second patterns are intersected is implemented using a plane not a mesh structure, there is a negative influence on visibility because the number of connection structures 300 and insulators 400 and an area on the plane are essentially increased. In order to solve such problems, an embodiment of the present invention proposes a method for forming patterns by controlling the line width of a pattern or the density of mesh structures.

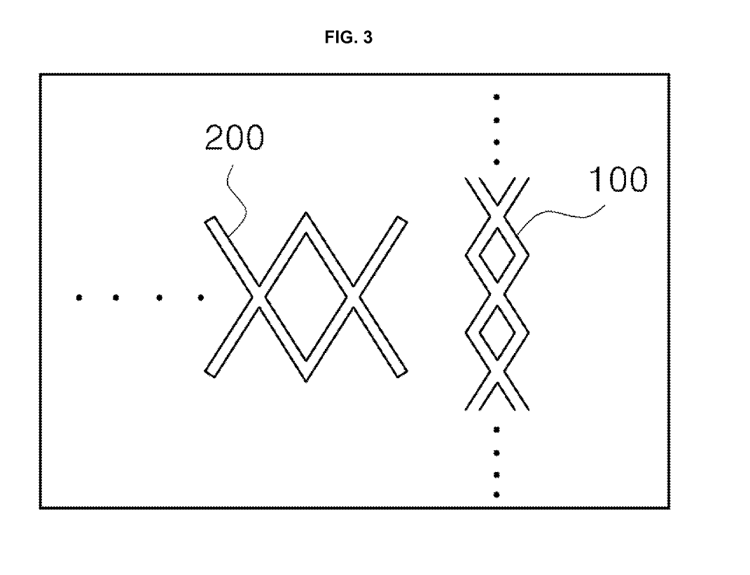

A method of forming the patterns according to the embodiment is described in more detail below with reference to FIG. 3.

FIG. 3 is an enlarged view of only a pattern structure within a D region of FIG. 2 in order to easily check the pattern structure in the intersection region.

As described above, the density of the mesh structures of the first patterns 100 in the intersection region may be denser than that of the mesh structures in a non-intersection region.

In this case, a criterion for determining the density of meshes may be various.

For example, the density of mesh structures may be determined based on the number of checked patterns per unit area. That is, the density of mesh structures may be set by determining an area of a specific length in the length and breadth of a touch panel and performing a comparison on the checked patterns of a pattern included in a corresponding area.

For another example, the density of mesh structures may be determined based on the diagonal length of a checked pattern. In general, a mesh structure means a structure in which a quadrangle checked pattern is repeated. Accordingly, if the mesh structure is formed based on a diagonal length in a specific direction of the checked pattern, a user can implement mesh structures having a desired density.

The density of mesh structures in an intersection region may be 1.2 to 5 times, 1.5 to 3 times, or 1.7 to 2 times greater than that of mesh structures in a non-intersection region. That is, the density of mesh structures in the intersection region may be a minimum of 1.2 times to a maximum of 5 times greater than that of mesh structures in the non-intersection region. The reason for this is that if the density of mesh structures in the intersection region is less than 1.2 times, a possibility that the mesh line of the first pattern in the intersection region may be disconnected is very high and if the density of mesh structures in the intersection region exceeds 5 times, the intersection region may not be formed to have a correct mesh structure and visibility is greatly reduced.

Furthermore, in the touch panel of FIG. 3 in accordance with an embodiment of the present invention, the visibility of the touch panel can be improved by controlling the line width of the first pattern 100 in the intersection region.

Specifically, if the line width of the first pattern 100 in the intersection region is minimized, a disconnection interval between the second patterns 200 can be reduced, and thus the volume of the insulator 400 and the connection structure 300 can also be reduced. There is a need for a method for reducing the line width of the first pattern 100 in the intersection region.

In this case, if the line width of the first pattern 100 in the intersection region is excessively reduced, there may be a negative effect on the resistance characteristic of the first pattern 100. Accordingly, the line width of the first pattern 100 in the intersection region may be reduced to about 1/2 times to 1/1.7 times compared to the line width of the first pattern 100 in the non-intersection region by taking into consideration a ratio of the density of mesh structures in the intersection region.

In another embodiment, the line width of the first pattern 100 may be implemented to be 0.1 μm to 10 μm, 1 μm to 5 μm, or 2 μm to 3 μm. That is, the line width of the first pattern 100 may have a minimum of 0.1 μm to a maximum of 10 μm. The reason for this is that it is impossible to implement a line width of less than 0.1 μm and there is a problem in that visibility is greatly reduced if the line width exceeds 10 μm.

If the line width of the first pattern 100 in the intersection region is reduced as described above, the visibility of a display device can be improved and the amount of raw materials for forming the insulator 400 and the connection structure 300 can also be significantly reduced because a total area of the touch panel versus a total plane area of the connection structure 300 or the insulator 400 can be reduced. Accordingly, there is an advantageous effect in terms of a production cost.

The first patterns 100 or second patterns 200 of the touch panel in accordance with an embodiment of the present invention are configured to have mesh shapes. In this case, the first patterns 100 or the second patterns 200 further include an organic binder.

That is, the first patterns 100 or the second patterns 200 formed in the mesh shapes may be formed to include any one of metal particles, such as silver (Ag), copper (Cu), and aluminum (Al). Furthermore, an organic binder may be further included in any one of the metal particles, such as silver (Ag), copper (Cu), and aluminum (Al). If the patterns are formed to further include the organic binder, there are advantages in that dendrite can be prevented from being formed, durability can be maintained in an environment including sweat and high humidity, and an oxidization phenomenon can be prevented.

As described above, the connection structure 300 may be made of any one of transparent conductive substances, such as indium tin oxide (ITO), indium zinc oxide (IZC), and zinc oxide (ZnO). In this case, it is to be understood that the connection structure 300 may have a mesh shape like an electrode pattern. Furthermore, the connection structure 300 may be formed to include any one of metal particles, such as silver (Ag), copper (Cu), and aluminum (Al). Furthermore, the connection structure 300 may include an organic binder that may be combined with any one of the metal particles.

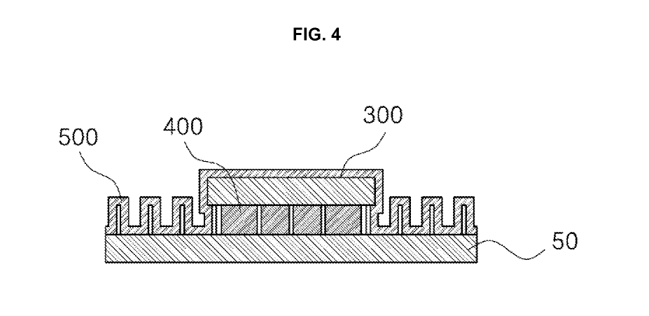

FIG. 4 illustrates an embodiment in which a protection layer 500 is further formed on the electrode pattern in the touch panel in accordance with an embodiment of the present invention. The protection layer 500 is formed to prevent metal particles, such as silver (Ag), copper (Cu), and aluminum (Al), or particles, including the metal particles and the organic binder, from being easily oxidized and to prevent reflection attributable to refraction if the electrode pattern 100, 200 or the connection structure 300 is formed to include any one of the metal particles or include any one of the metal particles and the organic binder.

The first patterns 100 and the second patterns 200 may be formed on the substrate 50 using a direct printing method.

In accordance with an embodiment of the present invention, there is an advantage in that the visibility of a display can be improved, in particular, visibility in a region in which patterns are intersected can be significantly improved because patterns of mesh structures are used.

Furthermore, in accordance with an embodiment of the present invention, there are advantages in that the connection structure can be easily included and visibility in other touch panel regions can be improved because the densities of meshes in a region in which patterns are intersected and a region in which patterns are not intersected are controlled.

Furthermore, in accordance with an embodiment of the present invention, there is an advantage in that excellent electrical properties can be implemented compared to a conventional transparent conductive body because patterns of mesh structures are used.

Furthermore, in accordance with an embodiment of the present invention, there are advantages in terms of a product fabrication period and a production cost because a process for forming a conventional transparent conductive body on a substrate can be greatly simplified.

Furthermore, in accordance with an embodiment of the present invention, there is an advantage in that a large-sized touch panel can be implemented by overcoming a resistive limit.

Furthermore, in accordance with an embodiment of the present invention, there are advantages in that a touch panel having a wide area can be implemented and the thickness of a touch panel can be reduced.

A touch panel in accordance with yet another embodiment of the present invention may be included in all display devices having a touch function, and may have various applications. Specifically, the touch panel in accordance with an embodiment of the present invention may be included in a variety of types of display devices that require a touch function, such as mobile communication terminals including smart phones, PDAs, and tablets, a dashboard within transportation means, navigators, and display terminals that may be installed indoors or outdoors.

Accordingly, the present invention has been made keeping in mind the above problems occurring in the prior art, and an object of the present invention is to provide a touch panel including patterns of mesh structures.

Another object of the present invention is to provide a touch panel in which the density of meshes in a region in which two mesh structure patterns are intersected is different from the density of meshes in a region in which the two mesh structure patterns are not intersected.

Yet another object of the present invention is to provide a touch panel in which the line width of one pattern is narrower than that of the other pattern in a structure in which the two patterns are intersected.

Further yet another object of the present invention is to provide a touch panel having a wide area and a reduced thickness.

Still yet another object of the present invention is to provide a touch panel capable of being fabricated using a simple and stable process.

In accordance with an embodiment of the present invention, a touch panel includes first patterns formed on a surface of a substrate, second patterns formed on the surface of the substrate in a direction different from the direction of the first patterns, wherein a region in which the second patterns intersect the first patterns is disconnected, an insulator configured to insulate the first patterns from the second patterns, and a connection structure configured to connect the disconnection region of the second patterns. The first patterns and the second patterns have mesh structures.

Furthermore, in the touch panel, the first patterns and the second patterns are formed in the same layer, the insulator is formed in a region in which the first patterns and the second patterns are intersected, and the connection structure is formed on top of the insulator.

Furthermore, in the touch panel, the connection structure also has a mesh structure.

Furthermore, the touch panel may be implemented so that the number of checked patterns per unit area in the region in which the first and the second patterns are intersected is greater than the number of checked patterns per unit area in a region in which the first and the second patterns are not intersected.

In this case, the number of checked patterns per unit area in the region in which the first and the second patterns are intersected may be 1.2 to 5 times greater than the number of checked patterns per unit area in the region in which the first and the second patterns are not intersected.

In the touch panel, the line width of the first pattern in the region in which the first pattern intersects the second pattern may be implemented to be narrower than that of the first pattern in the region in which the first pattern does not intersect the second pattern.

In this case, the line width of the first pattern in the region in which the first pattern intersects the second pattern may be implemented to be 0.1 μm to 10 μm.

In another touch panel, the first pattern or the second pattern includes a driving (Tx) electrode or a reception (Rx) electrode.

Furthermore, in the touch panel, the first pattern or the second pattern includes any one of silver (Ag), copper (Cu), and aluminum (Al), and may further include an organic binder.

In the touch panel, a protection layer may be further formed over the first patterns, the second patterns, and the connection structure.

Furthermore, in the touch panel, the connection structure is made of any one of transparent conductive substances including indium tin oxide (ITO), indium zinc oxide (IZC), and zinc oxide (ZnO).

Furthermore, in the touch panel, the first patterns or the second patterns are formed using a direct printing method.

In accordance with an embodiment of the present invention, a method of manufacturing a touch panel includes forming first patterns on a surface of a substrate, forming second patterns in a direction different from a direction of the first patterns on the surface of the substrate, wherein second patterns in a region in which the second pattern intersect the first patterns are disconnected, forming an insulator configured to insulate the first patterns from the second patterns, and forming a connection structure formed over the insulator and configured to connect the second patterns.

Furthermore, in the method of manufacturing a touch panel, the first patterns and the second patterns have mesh structures.

Furthermore, in the method of manufacturing a touch panel, the first patterns and the second patterns are simultaneously formed.

Furthermore, in the method of manufacturing a touch panel, the first patterns or the second patterns are formed using a direct printing method.

Furthermore, the method may further include forming a protection layer over the first patterns, the second patterns, and the connection structure.

Furthermore, in the method of manufacturing a touch panel, the insulator is formed in an intersection region in which the first patterns and the second patterns are intersected.

In accordance with an embodiment of the present invention, a display device including a touch panel includes first patterns formed on a surface of a substrate, second patterns formed on the surface of the substrate in a direction different from a direction of the first patterns, wherein a region in which the second patterns intersect the first patterns is disconnected, an insulator configured to insulate the first patterns from the second patterns, and a connection structure configured to connect the disconnection region of the second patterns. The first patterns and the second patterns have mesh structures.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A touch panel, comprising:
first patterns formed on a surface of a substrate;
second patterns formed on the surface of the substrate in a direction different from a direction of the first patterns, wherein a region in which the second patterns intersect the first patterns is disconnected;
an insulator configured to insulate the first patterns from the second patterns; and
a connection structure configured to connect the disconnection region of the second patterns,
wherein the first patterns and the second patterns have mesh structures.

2. The touch panel of claim 1, wherein:
the first patterns and the second patterns are formed in an identical layer,
the insulator is formed in a region in which the first patterns and the second patterns are intersected, and
the connection structure is formed on top of the insulator.

3. The touch panel of claim 1, wherein the connection structure has a mesh structure.

4. The touch panel of claim 1, wherein a number of checked patterns per unit area in the region in which the first and the second patterns are intersected is greater than a number of checked patterns per unit area in a region in which the first and the second patterns are not intersected.

5. The touch panel of claim 4, wherein the number of checked patterns per unit area in the region in which the first and the second patterns are intersected is 1.2 to 5 times greater than the number of checked patterns per unit area in the region in which the first and the second patterns are not intersected.

6. The touch panel of claim 1, wherein a line width of the first pattern in the region in which the first pattern intersects the second pattern is narrower than a line width of the first pattern in the region in which the first pattern does not intersect the second pattern.

7. The touch panel of claim 6, wherein the line width of the first pattern in the region in which the first pattern intersects the second pattern is 0.1 μm to 10 μm.

8. The touch panel of claim 1, wherein the first pattern or the second pattern comprises a driving (Tx) electrode or a reception (Rx) electrode.

9. The touch panel of claim 1, wherein the first pattern or the second pattern comprises any one of silver (Ag), copper (Cu), and aluminum (Al).

10. The touch panel of claim 9, wherein the first pattern or the second pattern further comprises an organic binder.

11. The touch panel of claim 1, further comprising a protection layer over the first patterns, the second patterns, and the connection structure.

12. The touch panel of claim 1, wherein the connection structure is made of any one of transparent conductive substances comprising indium tin oxide (ITO), indium zinc oxide (IZC), and zinc oxide (ZnO).

13. The touch panel of claim 1, wherein the first patterns or the second patterns are formed using a direct printing method.

14. A method of manufacturing a touch panel, comprising:
forming first patterns on a surface of a substrate;
forming second patterns in a direction different from a direction of the first patterns on the surface of the substrate, wherein second patterns in a region in which the second pattern intersect the first patterns are disconnected;
forming an insulator configured to insulate the first patterns from the second patterns; and
forming a connection structure formed over the insulator and configured to connect the second patterns.

15. The method of claim 14, wherein the first patterns and the second patterns have mesh structures.

16. The method of claim 14, wherein the first patterns and the second patterns are simultaneously formed.

17. The method of claim 14, wherein the first patterns or the second patterns are formed using a direct printing method.

18. The method of claim 14, further comprising forming a protection layer over the first patterns, the second patterns, and the connection structure.

19. The method of claim 14, wherein the insulator is formed in an intersection region in which the first patterns and the second patterns are intersected.

20. A display device comprising a touch panel, comprising:
first patterns formed on a surface of a substrate;
second patterns formed on the surface of the substrate in a direction different from a direction of the first patterns, wherein a region in which the second patterns intersect the first patterns is disconnected;
an insulator configured to insulate the first patterns from the second patterns; and
a connection structure configured to connect the disconnection region of the second patterns,
wherein the first patterns and the second patterns have mesh structures.
